(19) United States
(12) Patent Application Publication
(10) Pub. No.: US 2006/0212246 A1
(43) Pub. Date: Sep. 21, 2006

(54) Device for signal transmission between a plurality of devices under test and a testing equipment

(75) Inventors: Charles Chuang, Taipei Hsien (TW); Chih-Chiao Chang, Taipei Hsien (TW); Chia-Jung Chang, Taipei Hsien (TW); Li-Han Chang, Taipei Hsien (TW)

Correspondence Address: Ladas & Parry, Suite 2100, 5670 Wilshire Boulevard, Los Angeles, CA, 90036-5679, US

(73) Assignee: CHROMA ATE INC.

(21) Appl. No.: 11/082,475

(22) Filed: Mar. 16, 2005

(51) Int. Cl. G06F 19/00

(52) U.S. Cl. 702/84

(57) ABSTRACT

A signal transmission device includes a set of first nodes, each of which is connected electrically to a respective one of devices under test, a second node connected electrically to a testing equipment, a set of mechanical relays, each of which interconnects the second node and a respective first node, a controller coupled electrically to the mechanical relays and operable so as to actuate the mechanical relays in sequence, and a defect-detecting module coupled electrically to the second node, the controller and the mechanical relays. The defect-detecting module is operable so as to detect the presence of abnormal operation during actuation of one of the mechanical relays and to generate an alarm signal upon detecting the presence of the abnormal operation.

### BACKGROUND OF THE INVENTION

1. Field of the Invention

The invention relates to a signal transmission device, more particularly to a device for signal transmission between a plurality of devices under test and a testing equipment.

2. Description of the Related Art

In order to ensure quality of devices in a QC procedure, characteristics test for the devices is necessary. To shorten a QC procedure for a plurality of devices, there is provided a conventional device 2 for signal transmission between a plurality of devices under test (DUTs) 12, 13, 14 and a testing equipment 11, as shown in FIG. 1. The conventional device 2 includes a set of first nodes 25, 26, 27, each of which is connected electrically to a respective one of the DUTs 12, 13, 14; a second node 28 connected electrically to the testing equipment 11; a set of mechanical relays 22, 23, 24, each of which interconnects the second node 28 and a respective one of the first nodes 25, 26, 27; and a controller 21 coupled electrically to the mechanical relays 22, 23, 24 and operable so as to actuate the mechanical relays 22, 23, 24 in sequence.

Each of the mechanical relays 22, 23, 24 includes a relay switch 222, 232, 242 that interconnects the second node 28 and the respective one of the first nodes 25, 26, 27; and a relay coil 221, 231, 241 that is disposed adjacent to the relay switch 222, 232, 242 and that is interposed between the controller 21 and ground or some other fixed potential.

During testing, the controller 21 outputs control signals to each of the relay coils 221, 231, 241 so as to energize the relay switches 222, 232, 242 in sequence such that the DUTs 12, 13, 14 can be tested in sequence by the testing equipment 11.

When the controller 21 outputs a control signal as shown in FIG. 2a, in which the control signal includes a high-level component 201 maintained during a response time for a selected one of the mechanical relays 22, 23, 24 that is composed of an actuating period T₁ and a stable period T₂, and a low-level component 202 maintained during a releasing period T₃ to the selected one of the mechanical relays 22, 23, 24 to actuate the selected one of the mechanical relays 22, 23, 24, the selected one of the mechanical relays 22, 23, 24 has an impedance that is unstable and varies ranging from Z1 to Z0 within the actuating period T₁ as shown in FIG. 2b. The impedance of the selected one of the mechanical relays 22, 23, 24 within the stable period T₂ is Z0, and the impedance of the selected one of the mechanical relays 22, 23, 24 within the releasing period T₃ is unstable and varies ranging from Z0 to Z1.

With repeated testing, the mechanical relays 22, 23, 24 are easily worn or even destroyed, thereby resulting in abnormal operation of the conventional device 2 during testing. Therefore, the DUTs 12, 13, 14 cannot be correctly tested.

FIG. 3 illustrates an unreliability distribution of a lot of mechanical relays in a service life test. In view of FIG. 3, if all the mechanical relays used in the above conventional device are replaced after one million times of use as suggested by the manufacturer, almost 99% of the mechanical relays is wasted, thereby resulting in increased testing costs.

### SUMMARY OF THE INVENTION

Therefore, the object of the present invention is to provide a device for signal transmission between a plurality of devices under test and a testing equipment that is capable of detecting the presence of abnormal operation during use.

According to the present invention, there is provided a device for signal transmission between a plurality of devices under test and a testing equipment. The device comprises:

a set of first nodes, each of which is adapted to be connected electrically to a respective one of the devices under test;

a second node adapted to be connected electrically to the testing equipment;

a set of mechanical relays, each of which interconnects the second node and a respective one of the first nodes;

a controller coupled electrically to the mechanical relays and operable so as to actuate the mechanical relays in sequence; and

a defect-detecting module coupled electrically to the second node, the controller and the mechanical relays;

wherein the defect-detecting module is operable so as to detect the presence of abnormal operation during actuation of one of the mechanical relays and to generate an alarm signal upon detecting the presence of the abnormal operation.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram illustrating a conventional device for signal transmission between a plurality of devices under test and a testing equipment;

FIG. 2a is a graph showing a control signal output by a controller of the conventional device;

FIG. 2b is a graph showing an impedance of an actuated mechanical relay of the conventional device resulting from the control signal of FIG. 2a;

FIG. 3 illustrates an unreliability distribution of devices under test in a service life test;

FIG. 4 is a schematic circuit block diagram illustrating the first preferred embodiment of a device for signal transmission between a plurality of devices under test and a testing equipment according to this invention;

FIG. 5 is a schematic view showing a Hall sensor of the first preferred embodiment;

FIG. 6a is a graph showing a control signal output by a controller of the first preferred embodiment;

FIG. 6b is a graph showing a current flowing through a mechanical relay of the first preferred embodiment and generated in accordance with the control signal of FIG. 6a;

FIG. 7 is a schematic circuit block diagram illustrating the second preferred embodiment of a device for signal transmission between a plurality of devices under test and a testing equipment according to this invention;

FIG. 8 is a schematic circuit block diagram illustrating the third preferred embodiment of a device for signal transmission between a plurality of devices under test and a testing equipment according to this invention; and

FIG. 9 is a schematic circuit block diagram illustrating the fourth preferred embodiment of a device for signal transmission between a plurality of devices under test and a testing equipment according to this invention.

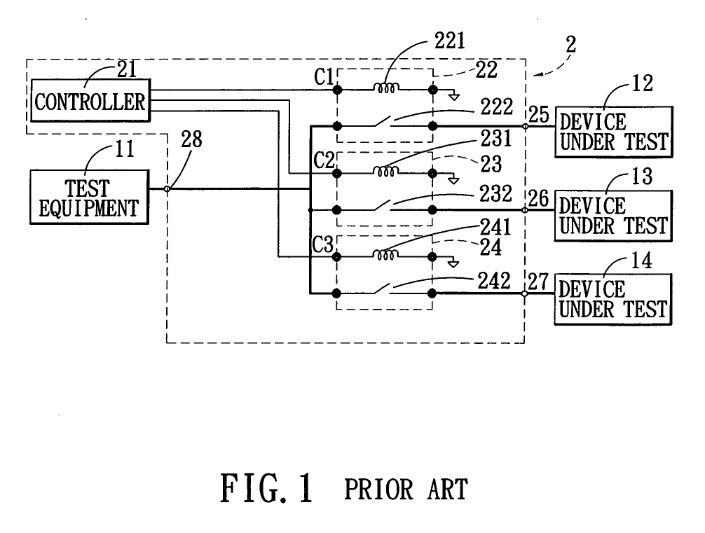

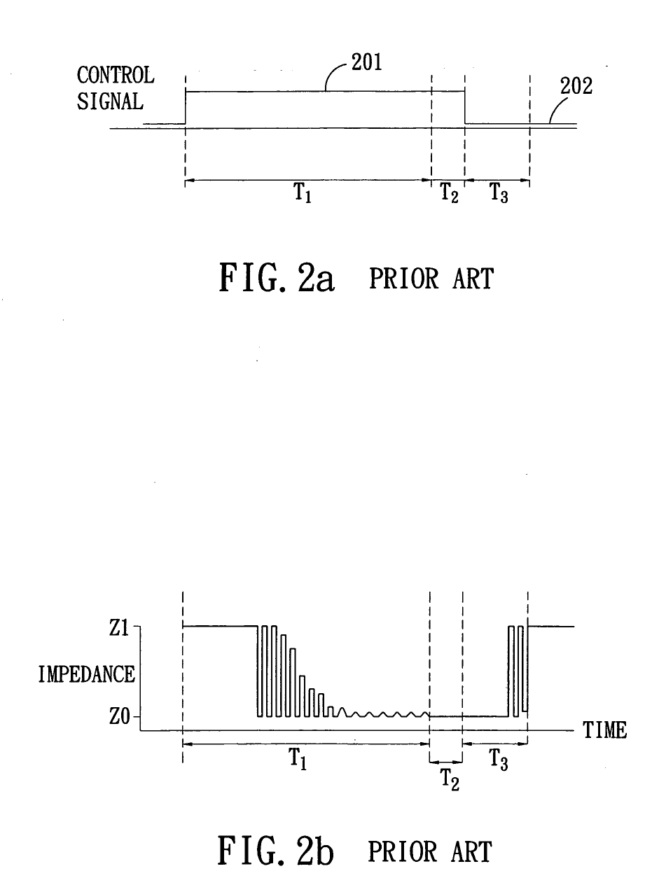

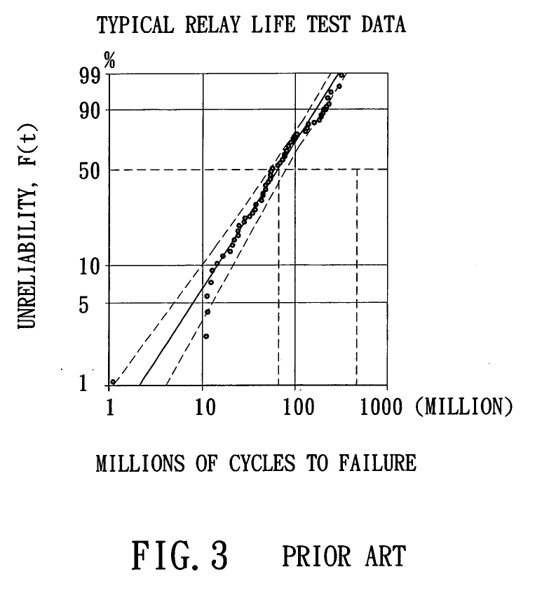

### DETAILED DESCRIPTION OF THE PREFERRED EMBODIMENTS

Before the present invention is described in greater detail, it should be noted that like elements are denoted by the same reference numerals throughout the disclosure.

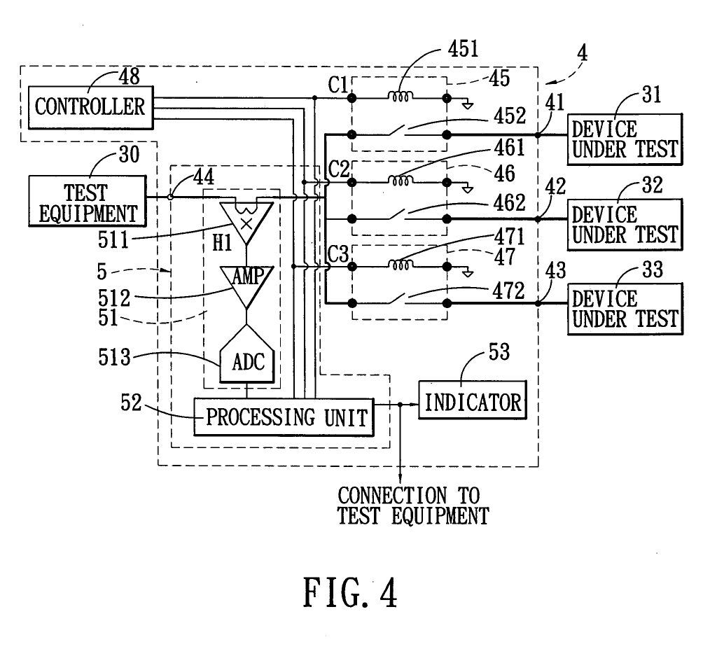

Referring to FIG. 4, the first preferred embodiment of a device 4 for signal transmission between a plurality of devices under test (DUTs) 31, 32, 33 and a testing equipment 30 according to the present invention is shown to include a set of first nodes 41, 42, 43, a second node 44, a set of mechanical relays 45, 46, 47, a controller 48, and a defect-detecting module 5.

Each of the first nodes 41, 42, 43 is adapted to be connected electrically to a respective one of the DUTs 31, 32, 33.

The second node 44 is adapted to be connected electrically to the testing equipment 30.

In this embodiment, each of the mechanical relays 45, 46, 47 includes a relay switch 452, 462, 472 that interconnects the second node 44 and a respective one of the first nodes 41, 42, 43, and a relay coil 451, 461, 471 that is disposed adjacent to the relay switch 452, 462, 472 and that is interposed between the controller 48 and ground.

The controller 48 is coupled electrically to the relay coils 451, 452, 453 of the mechanical relays 45, 46, 47, and is operable so as to actuate the mechanical relays 45, 46, 47 in sequence. More specifically, during testing, the controller 48 outputs control signals to each of the relay coils 451, 461, 471 so as to energize the relay switches 452, 462, 472 in sequence such that the DUTs 31, 32, 33 can be tested in sequence by the testing equipment 30.

FIGS. 6a shows a control signal output from the controller 48 to one of the mechanical relays 45, 46, 47. The control signal includes a high-level component 481 maintained during a response time for said one of the mechanical relays 45, 46, 47 that is composed of an actuating period T₁₁ and a stable period T₁₂, and a low-level component 482 maintained during a releasing period T₁₃.

As mechanical relay ages, the unstable period T₁₁ is extended and T₁₂ is shorted or eliminated. T₁₃ may also be extended which causes the current device under test not being properly released before the next test cycle starts.

The defect-detecting module 5 is coupled electrically to the second node 44, the controller 48 and the relay switches 452, 462, 472 of the mechanical relays 45, 46, 47. The defect-detecting module 5 is operable so as to detect the presence of abnormal operation during active test period denoted by T₁₂ in Figure or the extension of T₁₃ cycle into the next test cycle of one of the mechanical relays 45, 46, 47, and to generate an alarm signal upon detecting the presence of abnormal operation. In this embodiment, the defect-detecting module 5 includes a sensing unit 51 and a processing unit 52.

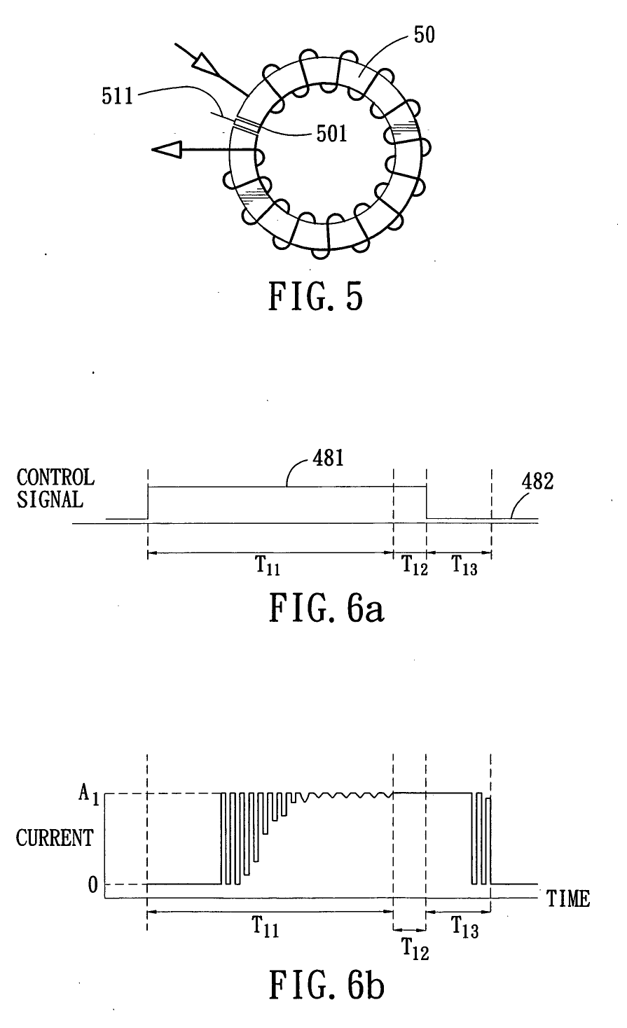

The sensing unit 51 is connected electrically to the second node 44 and the relay switches 452, 462, 472 of the mechanical relays 45, 46, 47 for sensing a characteristic variance associated with an actuated one of the mechanical relays 46, 47 and for generating a sensor signal corresponding to the characteristic variance sensed thereby. In this embodiment, the sensing unit 51 includes a current sensor, such as an A1321 Hall sensor 511 produced by Allegro Microsystems, Inc., an amplifier 512 connected electrically to the Hall sensor 511, and an analog-to-digital converter 513 connected electrically to the amplifier 512. Referring to FIG. 5, in order to obtain a reinforced magnetic-field intensity, the Hall sensor 511 is disposed in a gap 501 formed in a gapped toroid 50 wound by a wire with a plurality of turns, such as 100 turns. As an example of the operation of the Hall sensor 511 with a sensitivity of 5 mV/gauss, if a current flowing through the 100 turns of the wire wound on the gapped toroid 50 is 10 mA, a magnetic-field equal to 6.9 gauss (100×6.9 gauss/A×0.01=6.9 gauss) results such that the Hall sensor 511 senses a voltage output equal to 34.5 mV (5 mV/gauss×6.9 gauss=34.5 mV). Therefore, the Hall sensor 511 can sense a current variance associated with the actuated one of the mechanical relays 45, 46, 47 as the characteristic variance, and can generate a voltage variance corresponding to the current variance, as the sensor signal. More specifically, with reference to FIG. 6b, when the controller 48 outputs the control signal of FIG. 6a to a selected one of the mechanical relays 45, 46, 47 to actuate the selected one of the mechanical relays 45, 46, 47, a current flowing through the selected one of the mechanical relays 45, 46, 47 within the actuating period T₁₁ is unstable, and varies ranging from 0 to A1; the current flowing through the selected one of the mechanical relays 45, 46, 47 within the stable period T₁₂ is A1; and the current flowing through the selected one of the mechanical relays 45, 46, 47 within the releasing period T₁₃ is unstable, and varies ranging from A1 to 0. The amplifier 512 receives and amplifies the sensor signal from the Hall sensor 511. The analog-to-digital converter 513 converts the sensor signal amplified by the amplifier 512 into a digital sensor signal. It should be evident to those skilled in the art that a digital Hall sensor, such as the HAL 801 Hall sensor produced by Micronas Semiconductor Holding AG and which is integrated with amplifying and analog-to-digital converting functions therein, can also be used in the present invention.

The processing unit 52 is a device such as a microprocessor that is separate from the controller 48 in this embodiment. The processing unit 52 is connected electrically to the controller 48 and the sensing unit 51, receives the sensor signal from the sensing unit 51, compares the sensor signal with pre-established reference characteristic data, and generates an alarm signal based on the result of the comparison. In this embodiment, the reference characteristic data include a standard response time. The processing unit 52 calculates an actual response time from the sensor signal, and generates the alarm signal when the actual response time (i.e., T₁₁+T₁₂) is longer than the standard response time, a situation indicative of the presence of abnormal operation during use.

In this embodiment, the defect-detecting module 5 is adapted to be connected electrically to the testing equipment 30 such that the testing equipment 30 receives the alarm signal from the defect-detecting module 5. An indicator 53, such as a lamp, is connected electrically to the defect-detecting module 5 for receiving and reproducing the alarm signal therefrom.

Due to the presence of the defect-detecting module 5 capable of accurately detecting the presence of abnormal operation, mis-testing for the DUTs resulting from any abnormal mechanical relay can thus be avoided. Furthermore, the duration of the high-level component of the control signal from the controller 48 can be adjusted to be close to the actual response time, and the duration of the low-level component of the control signal from the controller 48 can be adjusted to be close to an actual releasing time, thereby resulting in an increased testing speed.

In addition to a defective mechanical relay, a tested element that is malfunctioning may also result in abnormal operation during testing. In order to identify the correct source of abnormal operation during testing, the preferred embodiments as described in the following are provided.

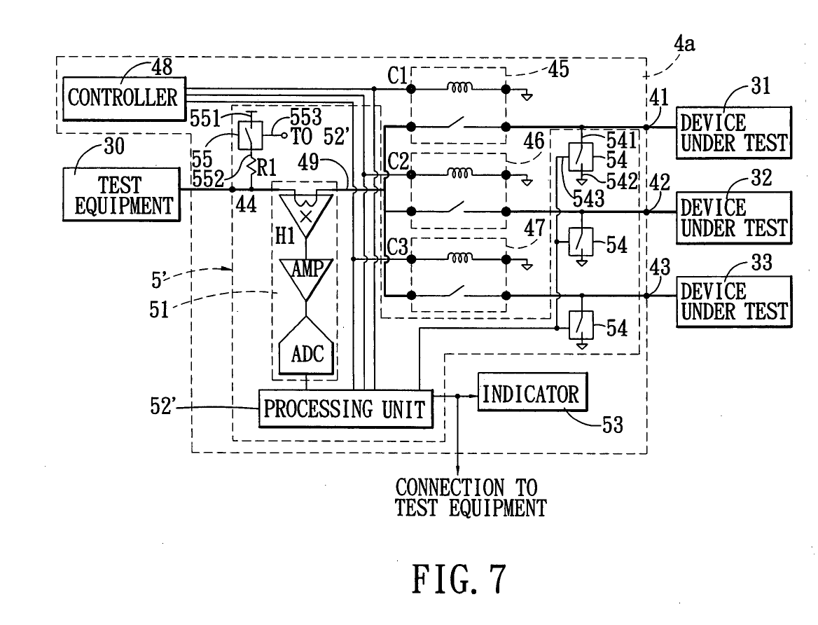

FIG. 7 illustrates the second preferred embodiment of a device (4a) for signal transmission between a plurality of the DUTs 31, 32, 33 and the testing equipment 30 according to this invention, which is a modification of the first preferred embodiment. Unlike the previous embodiment, a defect-detecting module 5′ of the second preferred embodiment further includes a set of first switches 54, and a second switch 55.

Each of the first switches 54 has a first terminal 541 coupled electrically to a respective one of the first nodes 41, 42, 43, a grounded second terminal 542, and a first control terminal 543 coupled electrically to a processing unit 52′.

The processing unit 52′ is operable so as to selectively switch on and switch off the first switches 54.

The second switch 55 has a biased third terminal 551, a fourth terminal 552 coupled electrically to the second node 44, and a second control terminal 553 coupled electrically to the processing unit 52′.

The processing unit 52′ is further operable so as to switch on and switch off the second switch 55 selectively.

To describe the second embodiment in greater detail, when the defect-detecting module 5′ detects the presence of abnormal operation during actuation of, for example, the mechanical relay 45 (i.e., an actual response time of the mechanical relay 45 is longer than the standard response time) , the processing unit 52′ switches on the first switch 54 connected electrically to the first node 41, as well as the second switch 55, and switches off the other first switches 54. Subsequently, the controller 48 actuates the mechanical relay 45. Therefore, the processing unit 52′ determines again whether the actual response time of the mechanical relay 45 is longer than the standard response time. If it is, the processing unit 52′ generates a first alarm signal indicating that the mechanical relay 45 is abnormal. Otherwise, the processing unit 52′ generates a second alarm signal indicating that the tested element 31 is abnormal.

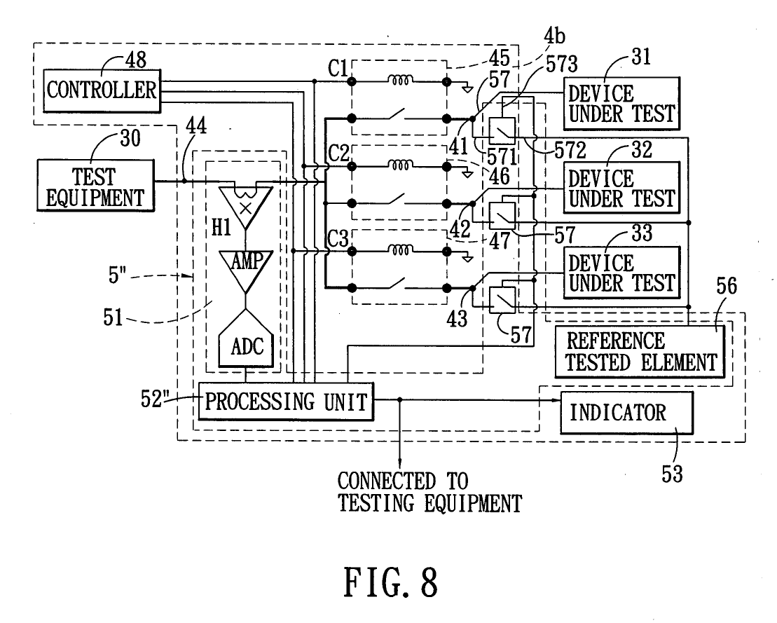

FIG. 8 illustrates the third preferred embodiment of a device (4b) for signal transmission between a plurality of the DUTs 31, 32, 33 and the testing equipment 30 according to this invention, which is a modification of the first preferred embodiment. Unlike the first embodiment, a defect-detecting module 5″ further includes a reference tested element 56, and a set of switches 57, each of which has a first terminal 571 coupled electrically to a respective one of the first nodes 41, 42, 43, a second terminal 572 coupled electrically to the reference tested element 56, and a control terminal 573 coupled electrically to the processing unit 52″.

The processing unit 52″ is operable so as to control the switches 57 for connecting the reference tested element 56 to a selected one of the mechanical relays 45, 46, 47.

To describe the third embodiment in greater detail, when the defect-detecting module 5″ detects the presence of abnormal operation during actuation of, for example, the mechanical relay 46 (i.e., an actual response time of the mechanical relay 46 is longer than the standard response time) , the processing unit 52″ switches on the switch 57 connected electrically to the first node 42, and switches off the other switches 57. Subsequently, the controller 48 actuates the mechanical relay 46. Therefore, the processing unit 52″ determines again whether the actual response time of the mechanical relay 46 is longer than the standard response time. If it is, the processing unit 52″ generates a first alarm signal indicating that the mechanical relay 46 is abnormal. Otherwise, the processing unit 52″ generates a second alarm signal indicating that the tested element 32 is abnormal.

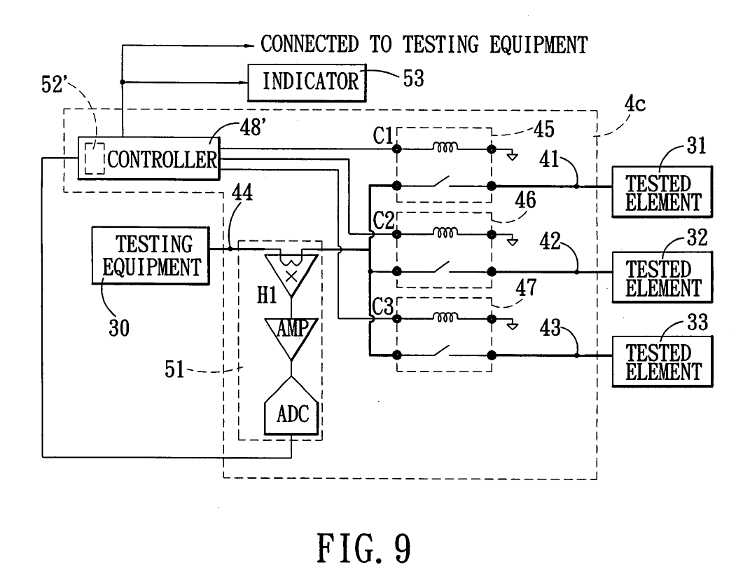

FIG. 9 illustrates the fourth preferred embodiment of a device (4c) for signal transmission between a plurality of the DUTs 31, 32, 33 and the testing equipment 30 according to this invention, which is a modification of the first preferred embodiment. In this embodiment, a controller 48′ includes program instructions for building the processing unit 52 of the defect-detecting module therein.

Due to the presence of the defect-detecting module 5, 5′, 5″, the device 4, (4a) , (4b) , (4c) of this invention can effectively and correctly determine the correct source of abnormal operation during testing (i.e., any damaged mechanical relay can be correctly detected after a relatively long service life) such that each mechanical relay can be effectively utilized so as to reduce costs in element replacement.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A device for signal transmission between a plurality of devices under test and a testing equipment, comprising:
a set of first nodes, each of which is adapted to be connected electrically to a respective one of the devices under test;
a second node adapted to be connected electrically to the testing equipment;
a set of mechanical relays, each of which interconnects said second node and a respective one of said first nodes;
a controller coupled electrically to said mechanical relays and operable so as to actuate said mechanical relays in sequence; and
a defect-detecting module coupled electrically to said second node, said controller and said mechanical relays;
wherein said defect-detecting module is operable so as to detect the presence of abnormal operation during actuation of one of said mechanical relays and to generate an alarm signal upon detecting the presence of the abnormal operation.

2. The device as claimed in claim 1, wherein said defect-detecting module includes
a sensing unit connected electrically to said second node and said mechanical relays for sensing a characteristic variance associated with an actuated one of said mechanical relays and for generating a sensor signal corresponding to the characteristic variance sensed thereby, and
a processing unit connected electrically to said controller and said sensing unit, receiving the sensor signal from said sensing unit, comparing the sensor signal with pre-established reference characteristic data, and generating the alarm signal based on the result of the comparison performed by said processing unit.

3. The device as claimed in claim 2, wherein said sensing unit includes a current sensor, and the characteristic variance is a current variance of the actuated one of said mechanical relays.

4. The device as claimed in claim 3, wherein said current sensor is a Hall sensor.

5. The device as claimed in claim 4, wherein said sensing unit further includes an amplifier connected electrically to said Hall sensor, and an analog-to-digital converter connected electrically to said amplifier.

6. The device as claimed in claim 3, wherein said current sensor is a digital Hall sensor.

7. The device as claimed in claim 2, wherein the reference characteristic data includes a standard response time,
said processing unit calculating an actual response time from the sensor signal, and generating the alarm signal when the actual response time is longer than the standard response time.

8. The device as claimed in claim 1, wherein said defect-detecting module is adapted to be connected electrically to the testing equipment such that the testing equipment receives the alarm signal from said defect-detecting module.

9. The device as claimed in claim 2, wherein said defect-detecting module further includes:
a set of first switches, each of which has a first terminal coupled electrically to a respective one of said first nodes, a grounded second terminal, and a first control terminal coupled electrically to said processing unit,
said processing unit being operable so as to switch on and switch off said first switches selectively; and
a second switch having a biased third terminal, a fourth terminal coupled electrically to said second node, and a second control terminal coupled electrically to said processing unit,
said processing unit being further operable so as to switch on and switch off said second switch selectively.

10. The device as claimed in claim 2, wherein said defect-detecting module further includes:
a reference tested element; and
a set of switches, each of which has a first terminal coupled electrically to a respective one of said first nodes, a second terminal coupled electrically to said reference tested element, and a control terminal coupled electrically to said processing unit;
said processing unit being operable so as to control said switches for connecting said reference tested element to a selected one of said mechanical relays.

11. The device as claimed in claim 2, wherein said processing unit is a microprocessor that is separate from said controller.

12. The device as claimed in claim 2, wherein said controller includes program instructions for building said processing unit of said defect-detecting module therein.
